(19) United States
(12) Patent Application Publication
(10) Pub. No.: US 2007/0046044 A1
(43) Pub. Date: Mar. 1, 2007

(54) Collision object discrimination apparatus for vehicle

(75) Inventor: Takatoshi Tanabe, Ichinomiya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/504,883

(22) Filed: Aug. 16, 2006

(30) Foreign Application Priority Data
Aug. 25, 2005 (JP) 2005-244364

(51) Int. Cl. B60R 19/02

(52) U.S. Cl. 293/120

(57) ABSTRACT

A collision object discrimination apparatus for a vehicle has a bumper absorber, a bumper reinforcement member, a support member, a load detection unit and a control unit for discriminating a sort of object colliding with a bumper based on a load detected by the load detection unit. The load detection unit has a first end and a second end opposite to teach other. The first end is connected to the bumper reinforcement member and the second end is connected to the support member. Further, the load detection unit is disposed such that at least a part of the load detection unit is located inside of the bumper reinforcement member.

### CROSS REFERENCE TO RELATED APPLICATION

This application is based on Japanese Patent Application No. 2005-244364 filed on Aug. 25, 2005, the disclosure of which is incorporated herein by reference.

### FIELD OF THE INVENTION

The present invention relates to a collision object discrimination apparatus for a vehicle for discriminating a sort of object colliding with the vehicle. The collision object discrimination apparatus is exemplary used to determine whether the object is a human such as a pedestrian.

### BACKGROUND OF THE INVENTION

Various methods and devices for detecting a collision load applied to a vehicle due to a vehicle collision have been known. For example, in Japanese Patent Publication No. 2004-212281 (US2004/0129479A1), a wire having a predetermined initial tension is transversely stretched along the front surface of a bumper reinforcement member of the vehicle. A collision load applied to the vehicle is detected by measuring a change of tension of the wire.

In Japanese Patent Publication No. 2004-156945, a pair of conductive wires are arranged parallel to each other and transversely at a front part of a vehicle so that the conductive wires can contact each other by a collision load applied to the vehicle. Thus, the collision is detected based on the contact between the conductive wires.

In Japanese Patent Publication No. 7-190732, an optical leak-type fiber is transversely arranged along a front bumper. A light emitting unit is arranged at an end of the fiber and a light receiving unit is arranged at an opposite end of the fiber. When the fiber is deformed or broken, the amount of light received in the light receiving unit is reduced. Thus, the collision is detected according to the change of the amount of light received in the light receiving unit.

Further, desires for protecting pedestrians at the time of collision between a vehicle and pedestrians have been recently increased. To meet such desires, various pedestrian protection apparatuses have been proposed. However, if the pedestrian protection apparatus is triggered when an object colliding with the vehicle is not a pedestrian, adverse influences are likely to be caused. Therefore, it is further desired to discriminate the pedestrian from other objects colliding with the vehicle.

For example, Japanese Patent Publication No. 11-28994 determines a collision object as a pedestrian based on a time duration in which a collision load exceeds a predetermined level.

Also, in Japanese Patent Publication No. 11-310095 (US6561301B1), the pedestrian is discriminated based on an increase rate of the collision load after the collision load exceeds a predetermined level. Further, it is also proposed to discriminate the pedestrian based on a peak value of the collision load.

As described above, the pedestrian is discriminated from other collision object according to whether a waveform (including magnitude) of the collision load detected by a collision load detection sensor, which is mounted on the vehicle, is within a predetermined range. In the predetermined range, a collision load waveform in a case where a pedestrian collides with a vehicle is included. Namely, the pedestrian is distinguished from other collision objects according to whether the detected collision load waveform is similar to the predetermined collision load waveform.

In a bumper of a vehicle, generally, a bumper absorber is arranged to extend in a vehicle right and left direction for absorbing collision energy. A bumper reinforcement member is arranged to extend in the right and left direction on a rear side of the bumper absorber. Side members are arranged on the rear side of the bumper reinforcement member and extends in a vehicle front and rear direction. In such a bumper structure, it is proposed to mount load sensors between the bumper reinforcement member and side members for discriminating a sort of object colliding with the bumper. The load sensors detect loads applied to the bumper due to the collision.

In such a structure, an entire structure of the bumper increases by the load sensors, as compared to the bumper without having the load sensors. Otherwise, it is necessary to reduce mounting spaces for other components on a periphery of the load sensors so as to maintain an entire size of the bumper equal to that of a bumper without having the load sensors. For example, to reduce the size increase of the bumper, the thickness of the bumper absorber and the bumper reinforcement member will be reduced. However, this may cause deterioration of a pedestrian protecting performance and a collision safety performance, for example. Further, structural rigidity between the bumper reinforcement member and the side members are likely to be reduced, resulting in deterioration of driving stability.

### SUMMARY OF THE INVENTION

The present invention is made in view of the foregoing matter, and it is an object of the present invention to provide a collision object discrimination apparatus for a vehicle, capable of reducing a large increase in a mounting space for a load detection unit in a bumper.

According to an aspect of the present invention, the collision object discrimination apparatus has a bumper absorber, a bumper reinforcement member, a support member, a load detection unit and a control unit. The bumper absorber is disposed to extend in a vehicle right and left direction in the bumper for absorbing collision energy. The bumper reinforcement member is disposed along the bumper absorber. The support member is disposed on a side opposite to the bumper absorber with respect to the bumper reinforcement member. The load detection unit has a first end and a second end opposite to each other. The first end of the load detection unit is connected to the bumper reinforcement member. The second end of the load detection unit is connected to the support member. Further, at least a part of the load detection unit is located inside of the bumper reinforcement member.

When a collision between the bumper and an object occurs, a load is transmitted to the bumper reinforcement member from the bumper absorber. At this time, a load applied to the bumper due to the collision object is detected by the load detection unit. Further, the control unit discriminates a sort of collision object based on the load detected by the load detection unit. For example, the control unit discriminates whether the collision object is a human e.g., pedestrian.

According to the above structure, at least a part of the load detection unit is located inside of the bumper reinforcement member. Namely, the above structure does not require a large space for mounting the load detection unit. Therefore, even when the load detection unit is mounted in the bumper, a size of the bumper is not largely increased as compared to that of the bumper without mounting the load detection unit. Furthermore, a design change around the bumper is reduced.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic block diagram of a collision object discrimination apparatus for a vehicle according to an example embodiment of the present invention;

FIG. 2 is a schematic plan view of a bumper of a vehicle with the collision object discrimination apparatus according to the example embodiment;

FIG. 3 is a schematic side view of the bumper with the collision object discrimination apparatus according to the example embodiment;

FIG. 4 is an enlarged schematic side view of a strain-type load sensor of the collision object discrimination apparatus disposed with respect to a bumper reinforcement member according to the example embodiment;

FIG. 5 is a side view of a bumper of a vehicle with a collision object discrimination apparatus as a comparative example;

FIG. 6 is a side view of a bumper of a vehicle with a collision object discrimination apparatus as another comparative example;

FIG. 7 is a schematic plan view of a bumper of a vehicle with a collision object discrimination apparatus according to a modification to the example embodiment of the present invention;

FIG. 8 is a schematic side view of the bumper with the collision object discrimination apparatus according to the modification; and

FIG. 9 is an enlarged schematic side view of a strain-type load sensor of the collision object discrimination apparatus shown in FIG. 8.

### DETAILED DESCRIPTION OF EXAMPLE EMBODIMENT

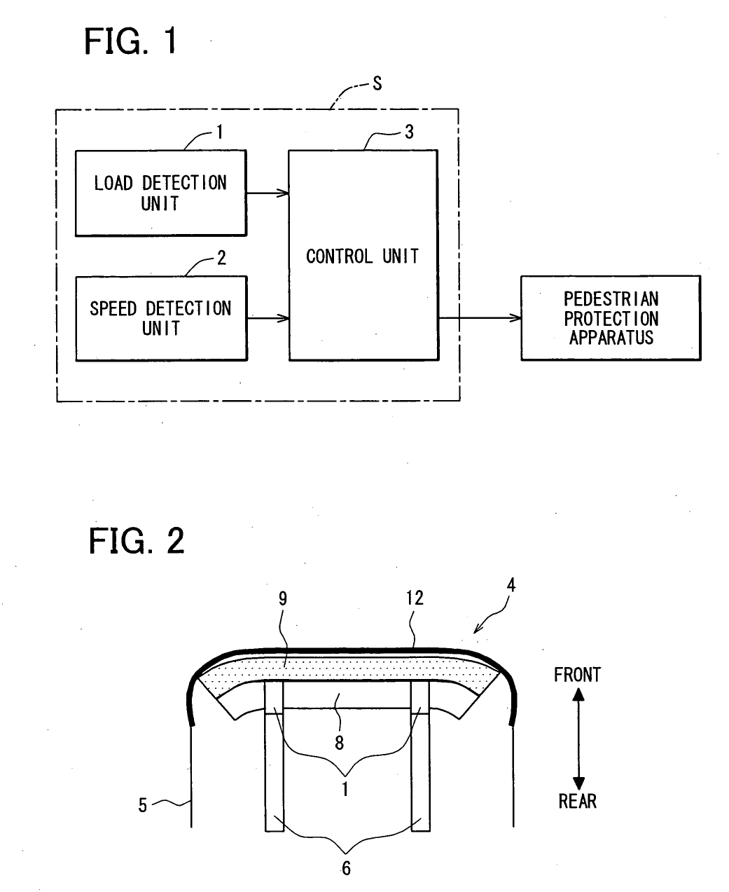

An example embodiment of a collision object discrimination apparatus of the present invention will now be described with reference to FIGS. 1 to 4. As shown in FIG. 1, the collision object discrimination apparatus S is mainly provided with a load detection unit 1, a vehicle speed detection unit 2 and a control unit 3 including a collision object discrimination circuit. The control unit 3 is connected to a pedestrian protection apparatus through a signal wire and the like. For example, the load detection unit 1 is constructed of at least one load sensor such as a strain-type load sensor, and the vehicle speed detection unit 2 is constructed of at least one speed sensor.

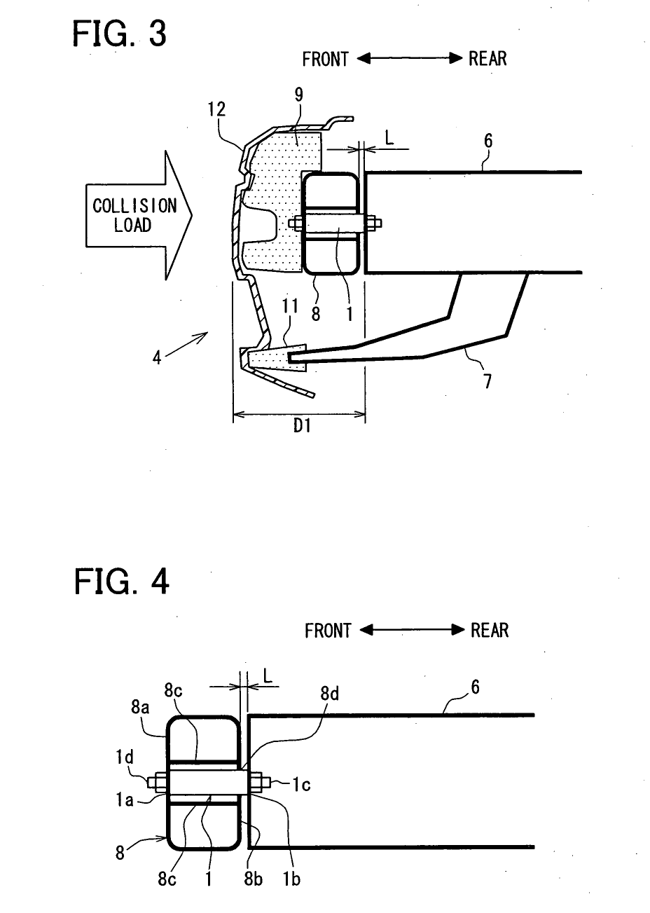

As shown in FIGS. 2 and 3, two side members 6 are provided in a substantially front part of a vehicle body 5, as support members. The side members 6 extend in a vehicle front and rear direction. Also, the side members 6 are spaced from each other in a vehicle right and left direction. For example, the load detection unit has two load sensors 1 corresponding to the number of side members 6.

Also, a bumper reinforcement member 8 is provided in front of the side members 6. The bumper reinforcement member 8 extends in the vehicle right and left direction. The bumper reinforcement member 8 is arranged with respect to the side members 6 such that a clearance L is defined between a rear wall 8b of the bumper reinforcement member 8 and front ends of the side members 6 in the vehicle front and rear direction. Here, the clearance L is defined for stroke of the load sensors 1 necessary for an appropriate load detection.

As shown in FIG. 4, the bumper reinforcement member 8 is a structural part of the vehicle. The bumper reinforcement member 8 forms a hollow space therein and has a substantially rectangular-shaped cross section. Further, the bumper reinforcement member 8 has two crossbeams 8c at substantially middle positions therein. The crossbeams 8c extends horizontally in the vehicle right and left direction inside of the bumper reinforcement member 8. Also, the crossbeams 8c are arranged parallel to each other and spaced from each other. The rear wall 8b of the bumper reinforcement member 8, which faces the front ends of the side members 6, forms openings 8d at positions corresponding to the front ends of the side members 6 and between the two crossbeams 8c.

Each of the load sensors 1 can be inserted and located in a space defined between the two crossbeams 8c in the bumper reinforcement member 8 through a corresponding one of the openings 8d. The load sensor 1 includes a strain gauge (not shown) that is adhered to a surface of a metal plate member having a crank-shape, for example. Each of the load sensors 1 has a first screw portion 1c on its rear end 1b that faces the front end of the corresponding side member 6. A through hole is formed on the front end of the side member 6.

The load sensor 1 is arranged such that the first screw portion 1c extends into the side member 6 through the through hole of the front end of the side member 6. Also, the first screw portion 1c is fastened with a nut. As such, the first screw portion 1c is fixed to the front end of the side member 6.

Further, the load sensor 1 has a second screw portion 1d on its front end 1a. The second screw portion 1d passes through a through hole formed on a front wall 8a of the bumper reinforcement member 8. Also, the second screw portion 1d is fastened with a nut. As such, the second screw portion 1d is fixed to the front wall 8a of the bumper reinforcement member 8.

Specifically, the load sensor 1 is inserted in the space defined between the crossbeams 8c through the opening 8d of the bumper reinforcement member 8. Further, the load sensor 1 is connected to the bumper reinforcement member 8 such that the front end 1a of the load sensor 1 contacts an inner surface of the front wall 8a of the bumper reinforcement member 8.

The load sensor 1 has a dimension (length) larger than a dimension of the bumper reinforcement member 8 with respect to the vehicle front and rear direction. For example, the dimension of the load sensor 1 is equal to a sum of the clearance L, the thickness of the rear wall 8b and an inner dimension of the bumper reinforcement member 8 with respect to the vehicle front and rear direction. For example, the dimension of the load sensor 1 from the front end 1a to the rear end 1b is 400 mm, and the clearance L for the predetermined stroke of the load sensor 1 is approximately 7 mm.

As shown in FIG. 3, the bumper 4 has an upper bumper absorber 9, a lower bumper absorber 11 and a bumper cover 12. The upper bumper absorber 9 is disposed at an upper location in the bumper 4. The upper bumper absorber 9 is disposed to extend in the vehicle right and left direction, in front of the front wall 8a of the bumper reinforcement member 8. The upper bumper absorber 9 has an elasticity to absorb collision energy. The upper bumper absorber 9 is for example made of a foamed resin.

Also, a lower bumper absorber 11 is provided at a position lower than the upper bumper absorber 9 in the bumper 4. The lower bumper absorber 11 extends in the right and left direction. The lower bumper absorber 11 has an elasticity to absorb collision energy. The lower bumper absorber 11 is for example made of a foamed resin. Also, the lower bumper absorber 11 is located at a position substantially equal to the upper bumper absorber 9 with respect to the vehicle front and rear direction.

Brackets 7 are provided under the side members 6. Each of the bracket 7 extends downwardly from a bottom surface of the corresponding side member 6 and further extends in the front direction. Further, a front end of the bracket 7 contacts and supports the lower bumper absorber 11. The bumper cover 12 is disposed in front of the upper bumper absorber 9 and the lower bumper absorber 11 to surround the bumper reinforcement member 8, the upper bumper absorber 9, and the lower bumper absorber 11 from the front side thereof. The bumper cover 12 also extends in the right and left direction.

The control unit 3 includes a signal processing circuit embedding a microcomputer therein. The control unit 3 determines whether or not an object colliding with the vehicle is a human (e.g., pedestrian) based on output signals from the load sensors 1 (or based on output signals from the load sensors 1 and output signals from the speed sensor 2). When it is determined that the object is a pedestrian, a pedestrian protection apparatus such as pedestrian protection airbags and a hood rising device is triggered.

Next, a collision object discrimination process of the collision object discrimination apparatus S will be described. When a load is applied to the bumper 4 due to a collision between an object and the vehicle, the load sensors 1 outputs collision load signals to the control unit 3. The control unit 3 calculates a total collision load by adding the loads detected by the sensors 1. Namely, the control unit 3 calculates the total collision load applied to the vehicle from the front side.

Then, the control unit 3 determines whether the total collision load is equivalent to a predetermined level that corresponds to a collision between the vehicle and a human. When it is determined that the total collision load is equivalent to the predetermined level, it is determined that the collision object is a human. In this case, the pedestrian protection apparatus is triggered based on a signal outputted from the control unit 3.

On the contrary, when the total collision load is not equivalent to the predetermined level, it is determined that the collision object is not a human. In this case, the pedestrian protection apparatus is not triggered.

Alternatively, the sort of the collision object can be discriminated based on the mass of the collision object. In this case, the total collision load detected by the load sensors 1 and the vehicle speed detected by the vehicle speed sensor 2 are input to the control unit 3, and further substituted into a map that previously memories the total load. Thus, the mass of the collision object can be calculated. For example, the mass of the collision object is a value that is obtained by dividing the total load by the rate of change of the speed.

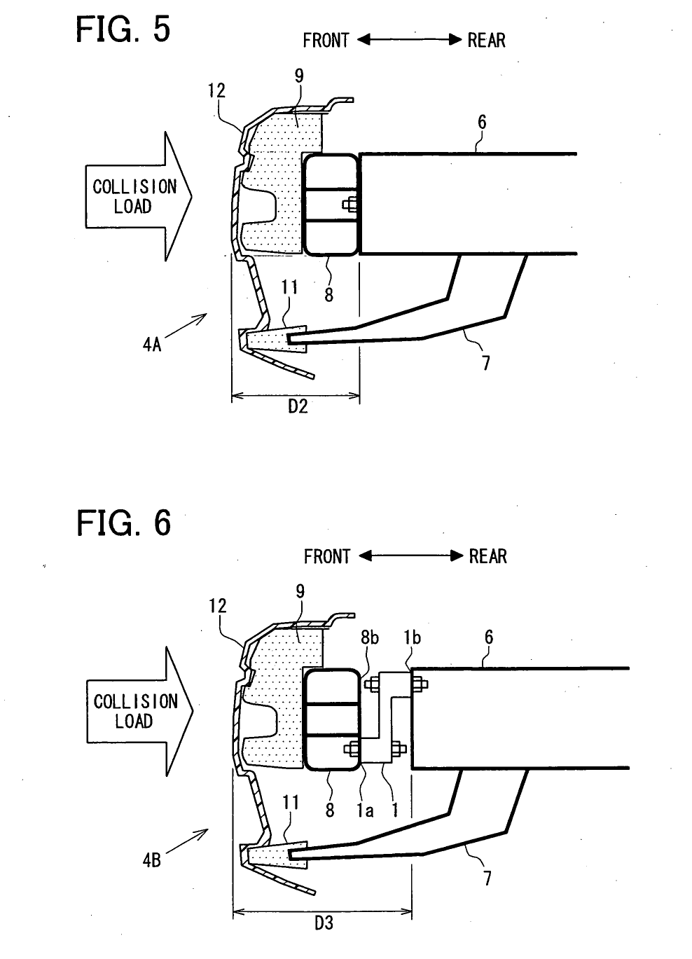

Next, a structure of the bumper 4 of the example embodiment shown in FIGS. 3 and 4 will be compared to structures of bumpers 4A, 4B shown in FIGS. 5 and 6. In a first comparative example shown in FIG. 5, the load sensors 1 are not mounted. Also, the bumper reinforcement member 8 is directly connected to the side members 6.

In a second comparative example shown in FIG. 6, load sensors 1 are mounted between the bumper reinforcement member 8 and the side members 6. For example, the front ends 1a of the load sensors 1 are connected to the rear wall 8b of the bumper reinforcement member 8. The rear ends 1b of the load sensors 1 are connected to the front ends of the side members 6.

In the second comparative example shown in FIG. 6, since the load sensors 1 are mounted between the rear wall 8b of the bumper reinforcement member 8 and the front ends of the side members 6, a dimension D3 between a front end of the bumper cover 12 and the front ends of the side members 6 is larger than a dimension D2 of the first comparative example shown in FIG. 5 by the dimension of the load sensors 1, with respect to the vehicle front and rear direction.

On the contrary, in the bumper 4 of the example embodiment, the predetermined portion of each load sensor 1 including the front end 1a thereof is located inside of the bumper reinforcement member 8. Namely, a predetermined length of the load sensor 1 overlaps the bumper reinforcement member 8 with respect to the vehicle front and rear direction. Further, the bumper reinforcement member 8 is spaced from the front ends of the side members 6 only with the predetermined clearance L for stroke of the load sensor 1. As such, in the bumper 4 of the example embodiment, a dimension D1 between the front surface of the bumper cover 12 and the front ends of the side members 6 is larger than the dimension D2 of the bumper 4A of FIG. 5 only by the small clearance L.

As described above, in the collision object discrimination apparatus S, the load sensors 1 are mounted such that the front ends 1a are connected to the front wall 8a of the bumper reinforcement member 8 and the rear ends 1b are connected to the side members 6. The load sensors 1 detect the collision loads L1 applied to the bumper 4 due to the object colliding with the bumper 4. The collision object discrimination apparatus S also has the control unit 6 as the collision object discrimination circuit for discriminating the sort of object collided with the bumper 4 based on the collision loads detected by the load sensors 1.

Further, each load sensor 1 is disposed such that at least a part of the load sensor 1 is located inside of the bumper reinforcement member 8. Further, the bumper reinforcement member 8 is spaced from the front ends of the side members 6 with the predetermined clearance L for the predetermined stroke of the load sensor 1 in the front and rear direction. Furthermore, the front end 1a of the load sensor 1 is connected to the inner surface of the front wall 8a of the bumper reinforcement member 8. The predetermined portion (length) of the load sensor 1 is located inside of the bumper reinforcement member 8.

Accordingly, even when the load sensors 1 are mounted in the bumper 4, an increase of size of the bumper 4 is only by the clearance L for the stroke of the load sensors 1. As such, peripheral components other than the sensors 1 can maintain those mounting spaces substantially equal to those of the bumper without having the load sensors 1. Also, the compatibility with other components can be maintained, irrespective of the presence or absence of the load sensors 1.

Therefore, even if the load sensors 1 are optionally mounted in the bumper 4, it is easy to cope with the arrangement in the bumper 4. For mounting the load sensors 1, only the bumper reinforcement member 8 and the side members 6 are partly modified. Therefore, it is not necessary to largely change the design of the bumper 4. Namely, the bumper can be similarly designed irrespective of the presence and absence of the load sensors 1.

Moreover, the clearance L defined between the bumper reinforcement member 8 and the side members 6 corresponds to a dimension required for the stroke of the load sensor 1. An excess stroke of the load sensor 1, exceeding the clearance L, will be restricted because the bumper reinforcement member 8 is brought into direct contact with the side members 6. Therefore, it is less likely that the load sensors 1 will excessively receive a load. Also, in a case that the collision load is on or more than the level to trigger airbags, the bumper reinforcement member 8 and the side members 6 immediately contact each other, so acceleration is transmitted. Therefore, the performance of the protection apparatus such as airbags will not be deteriorated.

Further, the bumper reinforcement member 8 has crossbeams 8c therein and the predetermined portion of the load sensor 1 including the front end 1a is housed in the space defined between the crossbeams 8c. Therefore, it is less likely that the strength of the bumper reinforcement member 8 will be reduced.

(Modifications)

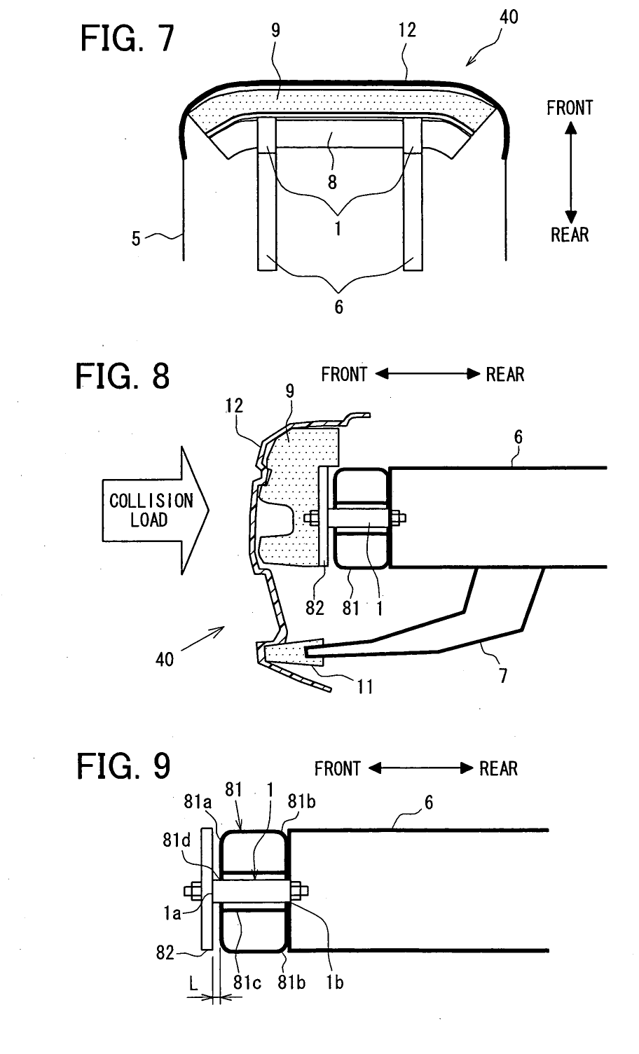

In the above example embodiment, the bumper reinforcement member 8 is spaced from the side members 6 with the predetermined clearance L for the stroke of the load sensor 1. The above structure can be modified as shown in FIGS. 7 to 9.

For example, in a bumper 40 shown in FIGS. 7 to 9, the bumper reinforcement member is constructed of a first bumper reinforcement member 81 and a second bumper reinforcement member 82. The first bumper reinforcement member 81 and the second bumper reinforcement member 82 are separate parts. The first bumper reinforcement member 81 is connected to the side members 6. The second bumper reinforcement member 82 is disposed in front of the first bumper reinforcement member 81 and on the rear side of the upper bumper absorber 12. Further, the second bumper reinforcement member 82 is spaced from a front wall 81a of the first bumper reinforcement member 81 with the clearance L for the predetermined stroke of the load sensor 1.

Here, the first bumper reinforcement member 81 has the shape similar to that of the bumper reinforcement member 8 shown in FIGS. 3 and 4. The first bumper reinforcement member 81 has crossbeams 81c, similar to the crossbeams 8c shown in FIGS. 3 and 4. The first bumper reinforcement member 81 has openings 81d on the front wall 81a at positions corresponding to a space defined between the crossbeams 81c. Further, the load sensors 1 are inserted in the space defined between the crossbeams 81c through the openings 81d.

The second bumper reinforcement member 82 has a plate shape and is made of resin or metal such as iron. The front ends 1a of the load sensor 1 are connected to the second bumper reinforcement member 82. Further, the predetermined portion (length) of the load sensor 1 is housed in the bumper reinforcement member 81.

In the example embodiment shown in FIGS. 7 to 9, the first bumper reinforcement member 81, which has the structure similar to the bumper reinforcement member 8, is connected to the side members 6. Therefore, structural rigidity between the bumper reinforcement member 81 and the side members 6 is ensured, and the deterioration of the driving stability will be restricted.

Further, the load sensors 1 are partly located inside of the first bumper reinforcement member 81. Namely, the load sensors 1 overlap the first bumper reinforcement member 81 for a predetermined length in the vehicle front and rear direction. Therefore, a size of the bumper 4 due to arrangement of the load sensors 1 therein is increased only by the thickness of the second bumper reinforcement member 82 and the clearance L, as compared to that of the bumper 4A of FIG. 5. Thus, the size of the bumper 4 is not largely increased, even when the load sensors 1 are mounted in the bumper 4.

Moreover, the predetermined clearance L is provided for stroke of the load sensor 1. Therefore, an excess stroke of the load sensors 1, exceeding the clearance L, can be reduced because the second bumper reinforcement member 82 is brought into direct contact with the first bumper reinforcement member 81. As such, it is less likely that the load sensors 1 will excessively receive loads. Also, against the impact that is on the level of triggering the air bags, the second bumper reinforcement member 82, the first bumper reinforcement member 81 and the side members 6 immediately contact, so acceleration is transmitted. Therefore, performance of the protection apparatus such as airbags is not reduced.

Further, the shape of the load sensor 1 is not limited to the crank shape. The load sensor 1 can have any shapes. Also, the number of the load sensors 1 is not limited to two. For example, the collision object discrimination apparatus S can have more than two load sensors 1. Further, plural load sensors 1 can be provided for each of the side members 6. As the load sensors 1, sensors other than the strain-type load sensor can be used.

In the above example embodiments, the rear ends 1b of the load sensors 1 are connected to the front wall of the side members 6. Alternatively, in a bumper that has a crushable box in front of the side members 6, the rear ends 1b of the load sensors 1 can be connected to a front surface of the crushable box. In this case, the crushable box corresponds to the support member.

Further, in the above example embodiments, the collision object discrimination apparatus S has the speed sensor 5. In a case that the collision object is determined based on the detected collision loads, the speed sensor 5 can be eliminated.

Also, the cross-sectional shape of the bumper reinforcement member 8, 81 is not limited to the illustrated shape. The number of the crossbeams 8c, 81c is not limited to two. Further, the front end 1a of the load sensor 1 can be connected to an inner portion of the bumper reinforcement member, instead of the inner surface of the front side wall 8a.

The example embodiments of the present invention are described above. However, the present invention is not limited to the above example embodiments, but may be implemented in other ways without departing from the spirit of the invention.

What is claimed is:

1. A collision object discrimination apparatus for a vehicle, comprising:
a bumper absorber disposed to extend in a vehicle right and left direction in a bumper of the vehicle for absorbing collision energy;
a bumper reinforcement member disposed along the bumper absorber;
a support member disposed on a side opposite to the bumper absorber with respect to the bumper reinforcement member;
a load detection unit that detects a load applied to the bumper due to an object colliding with the bumper, the load detection unit having a first end and a second end opposite to each other, the first end connected to the bumper reinforcement member and the second end connected to the support member; and
a control unit electrically connected to the load detection unit for discriminating a sort of the object based on the load detected by the load detection unit,
wherein at least a part of the load detection unit is located inside of the bumper reinforcement member.

2. The collision object discrimination apparatus according to claim 1, wherein
the bumper reinforcement member has at least two crossbeams disposed inside of the bumper reinforcement member,
the crossbeams are spaced from each other to define a space therebetween, and
the load detection unit is disposed such that at least a part of the load detection unit is located inside of the space defined between the crossbeams.

3. The collision object discrimination apparatus according to claim 1, wherein
the bumper reinforcement member has a first side wall and a second side wall opposite to each other, the second side wall faces the support member,
the bumper reinforcement member is spaced from the support member such that a predetermined clearance is defined between the second side wall thereof and the support member for stroke of the load detection unit, and
the first end of the load detection unit is connected to the first side wall of the bumper reinforcement member such that a predetermined portion of the load detection unit including the first end is located inside of the bumper reinforcement member.

4. The collision object discrimination apparatus according to claim 1, wherein
the bumper reinforcement member has a first side wall and a second side wall opposite to each other, the second side wall faces the support member,
the bumper reinforcement member is spaced from the support member such that a predetermined clearance is defined between the second side wall thereof and the support member for stroke of the load detection unit, and
the first end of the load detection unit is connected to an inside of the bumper reinforcement member such that a predetermined portion of the load detection unit including the first end is located inside of the bumper reinforcement member.

5. The collision object discrimination apparatus according to claim 1, wherein
the bumper reinforcement member includes a first part and a second part, the first part and the second part are separate parts, the first part is connected to the support member, the second part is disposed on a side opposite to the support member with respect to the first part, and
the first part is spaced from the second part with a predetermined clearance for stroke of the load detection unit, and
the first end of the load detection unit is connected to the second part and a predetermined portion of the load detection unit including the second end is located inside of the first part.

6. The collision object discrimination apparatus according to claim 1, wherein
the support member includes a first side member and a second side member, the first side member and the second side member are spaced from each other with respect to the vehicle right and left direction and extend in a vehicle front and rear direction, and
the load detection unit includes load sensors, and at least one load sensor is disposed to each of the first side member and the second side member.

7. The collision object discrimination apparatus according to claim 1, wherein the load detection unit includes a strain-type load sensor.

8. The collision object discrimination apparatus according to claim 1, wherein
the bumper absorber has an upper absorber and a lower absorber that is disposed lower than the upper absorber, and
the bumper reinforcement member is disposed to face the upper absorber.

9. The collision object discrimination apparatus according to claim 1, wherein
the reinforcement member forms an opening on its side wall, and the load detection unit is disposed through the opening.

10. The collision object discrimination apparatus according to claim 1, wherein the first end of the load detection unit is in contact with an inner wall of the bumper reinforcement member.

11. The collision object discrimination apparatus according to claim 1, wherein
the bumper reinforcement member has a first side wall and a second side wall opposite to each other, the second side wall facing the support member,
the second side wall of the bumper reinforcement member is spaced from the support member with a predetermined clearance for stroke of the load detection unit, and
a sum of the clearance, a thickness of the second side wall of the bumper reinforcement member and an inner dimension of the bumper reinforcement member is equal to a dimension of the load detection unit with respect to a vehicle front and rear direction.

12. The collision object discrimination apparatus according to claim 1, further comprising:
a speed detection unit having at least one speed sensor for detecting a speed of the vehicle, wherein
the control unit determines the sort of the object based on a mass of the object calculated from the load detected by the load detection unit and the speed detected by the speed detection unit.

13. The collision object discrimination apparatus according to claim 1, wherein the control unit triggers a pedestrian protection apparatus disposed to the vehicle, when it is determined that the object is a human.
